(19) United States
(12) Patent Application Publication
(10) Pub. No.: US 2025/0236754 A1
(43) Pub. Date: Jul. 24, 2025

(54) WATERBORNE POLYVINYLIDENE DIFLUORIDE COATING COMPOSITIONS

(71) Applicant: Dow Global Technologies LLC, Midland, MI (US)

(72) Inventors: Peng Gao, Shanghai (CN); Cheng Shen, Shanghai (CN); Meijia He, Shanghai (CN); Chenbo Shen, Shanghai (CN)

(21) Appl. No.: 18/702,087

(22) PCT Filed: Nov. 5, 2021
(86) PCT No.: PCT/CN2021/128873

§ 371 Date: Apr. 17, 2024

(51) Int. Cl. C09D 127/16; C09D 7/45; C09D 7/63; C09D 7/65

(52) U.S. Cl. CPC C09D 127/16; C09D 7/45; C09D 7/63; C09D 7/65

(57) ABSTRACT

A coating composition includes water; a plurality of polyvinylidene difluoride particles; and a surfactant having a hydrophobe branching degree of 5 or greater, wherein the composition is free of a fluorinated surfactant.

### BACKGROUND

### Field of the Disclosure

The present disclosure relates to coating compositions, and more specifically to coating compositions comprising polyvinylidene difluoride.

### Introduction

Polyvinylidene difluoride (“PVDF”), as well as other fluoropolymers such as polytetrafluoroethylene (“PTFE”), are typically formed in a multistep process. For example, United States Patent Application Publication number 2021/0032381 explains that a frequently used method for producing PTFE involves aqueous emulsion polymerization of fluorinated monomers. The aqueous emulsion polymerization typically uses a fluorinated surfactant and may include a non-ionic surfactant such as a polyoxyethylene alkyl ether surfactant. The fluorinated surfactant is essential in maintaining the emulsions. Once the emulsion polymerization is complete, a step of concentrating the solids and removal of the fluorinated surfactant is performed. The solid fluoropolymer may then be collected and used.

PVDF is a fluoropolymer used to create high performance coatings that provide good resistance to solvents, chemicals, weather and heat. Unlike PTFE and other fluoropolymers, PVDF is not a fully fluorinated polymer and has a repeating chemical structure of CH₂CF₂. This unique chemical structure leads to PVDF having a low surface energy and a relatively high density of 1.8 grams per cubic centimeter (“g/cc”) to 1.9 g/cc. The low surface energy and high density of PVDF typically leads to agglomeration and separation of the PVDF particles when used in aqueous dispersions and as such typically fluorinated surfactants are used. Use of such aqueous dispersions in coating applications is challenging as the agglomeration and separation results in an uneven coating of the particles on a substrate. Additionally, agglomerates tend to become tightly packed within less than 7 days of forming the aqueous dispersion. The tightly packed agglomerates are no longer capable of being re-dispersed thereby limiting the usable life of the aqueous dispersion. Therefore, achieving a stable dispersion that is able to retain its uniformity or at least be re-dispersible after a period of 7 days would be advantageous.

Fluorinated surfactants are typically required to create stable aqueous dispersions, but the inclusion of fluorinated surfactants presents environmental concerns for disposal. Various attempts at creating stable PVDF aqueous dispersions without fluorinated surfactants have been attempted. For example, United States Patent Application Publication number 2015/0030906 provides for the formation of aqueous dispersions of PVDF using non-fluorinated surfactants, but such dispersions are used immediately because of the tendency for PVDF to agglomerate and separate quickly.

In view of the above teachings, it would be surprising to discover an aqueous dispersion of PVDF that is initially uniform and is re-dispersible after a period of 7 days.

### SUMMARY OF THE DISCLOSURE

The present disclosure provides an aqueous dispersion of PVDF that is initially uniform and is re-dispersible after a period of 7 days. The present invention is a result of discovering that highly branched surfactants are able to not only create initially uniform aqueous dispersions of PVDF, but that the highly branched surfactants can maintain the re-dispersibility of the PVDF after prolonged shelf time. Without being bound by theory, it is believed that surfactants having a hydrophobe branching degree of 5 or greater are able to prevent the tight agglomeration of PVDF particles at least in part through steric hinderance. By preventing the tight agglomeration of the PVDF particles, the aqueous dispersion may either maintain a uniform dispersion over time or may be quickly re-dispersible.

The present disclosure is particularly useful for the formation of coating compositions.

According to a first feature of the present disclosure, a coating composition comprises water; a plurality of polyvinylidene difluoride particles; and a surfactant having a hydrophobe branching degree of 5 or greater, wherein the composition is free of a fluorinated surfactant.

According to a second feature of the present disclosure, the surfactant is a non-ionic surfactant.

According to a third feature of the present disclosure, a weight ratio of the surfactant to the polyvinylidene difluoride particles is from 2.0% to 15.0%.

According to a fourth feature of the present disclosure, the coating composition comprises from 20 wt % to 70 wt % of the polyvinylidene difluoride particles based on a total weight of the coating composition.

According to a fifth feature of the present disclosure, the coating composition further comprises 0.1 wt % to 10.0 wt % of a dispersant, wherein the dispersant is a random copolymer of diisobutylene and maleic anhydride.

According to a sixth feature of the present disclosure, the coating composition further comprises 0.1 wt % to 10.0 wt % of a dispersant, wherein the dispersant has structure (II) wherein each AO may independently be ethylene oxide, propylene oxide, butylene oxide and combinations thereof in random or block order, further wherein each n of Structure (II) may independently be from 5 to 40.

According to a seventh feature of the present disclosure, the surfactant has structure (I) wherein n of Structure (I) is 3 to 11 and R₁ for each n is independently selected from the group consisting of H or an alkyl having 1 or 2 carbons.

According to an eighth feature of the present disclosure, n of Structure (I) is 8 to 11 and R₁ is H.

According to a ninth feature of the present disclosure, the method includes a step of dispersing a plurality of polyvinylidene difluoride particles in a mixture of water and a surfactant having a hydrophobe branching degree of 5 or greater, wherein the composition is free of a fluorinated surfactant.

According to a tenth feature of the present disclosure, a method of coating a substrate, comprises the step of applying the coating composition of claim 9 to a substrate.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

As used herein, the term weight percent (“wt %”) designates the percentage by weight a component is of a total weight of the coating composition unless otherwise indicated. As used herein, a “CAS number” is the chemical services registry number assigned by the Chemical Abstracts Service.

### Coating Composition

The present disclosure is directed to a coating composition. The coating composition comprises water, a plurality of polyvinylidene difluoride particles, and a surfactant having a hydrophobe branching degree of 5 or greater. The coating composition is free of fluorinated surfactants. As used herein, the term “free of” is defined to mean that the coating composition comprises 0.001 wt % or less of the material it is free of. The coating composition may comprise a dispersant and/or other additives. The coating composition may comprise 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less of water based on a total weight of the coating composition. The coating composition may be useful in the formation of coatings on battery separators and other applications where the uniform deposition of PVDF particles using an aqueous dispersion would be advantageous. Further, as the coating composition is free of fluorinated surfactants, the coating composition has less associated environmental impacts.

### Polyvinylidene Difluoride

The coating composition comprises polyvinylidene difluoride. The PVDF is in the form of a plurality of particles. The PVDF may include homopolymers, copolymers, and terpolymers within its meaning. The PVDF may be 50 mole percent (“mol %”) or greater, or 75 mol % or greater, or 80 mol % or greater, or 85 mol % or greater of polyvinylidene difluoride copolymerized with at least one comonomer selected from the group consisting of tetrafluoroethylene, trifluoroethylene, chlorotrifluoroethylene, hexafluoropropene, vinyl fluoride, pentafluoropropene, tetrafluoropropene, perfluoromethyl vinyl ether, perfluoropropyl vinyl ether, other monomers and combinations thereof. The PVDF may be 100 mol % polyvinylidene difluoride and contain no additional comonomers. The PVDF particles may have a diameter or largest length dimension of 20 nm or greater, or 50 nm or greater, or 100 nm or greater, or 200 nm or greater, or 300 nm or greater, or 400 nm or 500 nm or less. The PVDF may be formed by aqueous free-radical emulsion polymerization, suspension polymerization, solution polymerization and supercritical CO2 polymerization.

The coating composition may comprise 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less of the PVDF particles based on a total weight of the coating composition.

### Surfactant

The coating composition comprises the surfactant. Surfactants comprise both a hydrophobic moiety (“hydrophobe”) and a hydrophilic moiety. The hydrophobe of a surfactant may be linear (i.e., straight chain) or branched (thus have a degree of branching greater than 1). The degree of branching is determined by counting the number of hydrophobic moieties extending from a backbone chain of the hydrophobe. The surfactant has a hydrophobe branching degree of 5 or greater, or 6 or greater, or 7 or greater, or 8 or greater, or 9 or greater. The surfactant may be a single surfactant or a mixture of surfactants. The surfactant may be characterized by Structure (I)

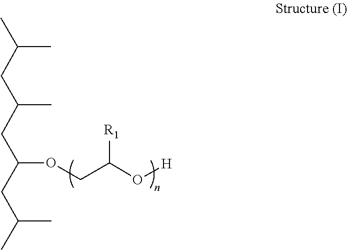

wherein n of Structure (I) is 3 to 11 and R₁ for each n is independently selected from the group consisting of H or an alkyl having 1 or 2 carbons. For example, n of Structure (I) may be 3, or 4, or 5, or 6, or 7, or 8, or 9, or 10, or 11.

The coating composition comprises from 0.1 wt % to 10.0 wt % of the surfactant based on the total weight of the coating composition. For example, the coating composition may comprise 0.1 wt % or greater, or 0.5 wt % or greater, or 1.0 wt % or greater, or 1.5 wt % or greater, or 2.0 wt % or greater, or 2.5 wt % or greater, or 3.0 wt % or greater, or 3.5 wt % or greater, or 4.0 wt % or greater, or 4.5 wt % or greater, or 5.0 wt % or greater, or 5.5 wt % or greater, or 6.0 wt % or greater, or 6.5 wt % or greater, or 7.0 wt % or greater, or 7.5 wt % or greater, or 8.0 wt % or greater, or 8.5 wt % or greater, or 9.0 wt % or greater, or 9.5 wt % or greater, while at the same time, 10.0 wt % or less, or 9.5 wt % or less, or 9.0 wt % or less, or 8.5 wt % or less, or 8.0 wt % or less, or 7.5 wt % or less, or 7.0 wt % or less, or 6.5 wt % or less, or 6.0 wt % or less, or 5.5 wt % or less, or 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less, or 0.5 wt % or less, or 0.2 wt % or less of the surfactant based on the total weight of the coating composition.

The coating composition may have a surfactant to PVDF weight ratio of 2% to 15%. For example, the surfactant to PVDF weight ratio may be 2.0% or greater, or 2.5% or greater, or 3.0% or greater, or 3.5% or greater, or 4.0% or greater, or 4.5% or greater, or 5.0% or greater, or 5.5% or greater, or 6.0% or greater, or 6.5% or greater, or 7.0% or greater, or 7.5% or greater, or 8.0% or greater, or 8.5% or greater, or 9.0% or greater, or 9.5% or greater, or 10.0% or greater, or 10.5% or greater, or 11.0% or greater, or 11.5% or greater, or 12.0% or greater, or 12.5% or greater, or 13.0% or greater, or 13.5% or greater, or 14.0% or greater, or 14.5% or greater, while at the same time, 15.0% or less, or 14.5% or less, or 14.0% or less, or 13.5% or less, or 13.0% or less, or 12.5% or less, or 12.0% or less, or 11.5% or less, or 11.0% or less, or 10.5% or less, or 10.0% or less, 9.5% or less, or 9.0% or less, 8.5% or less, or 8.0% or less, 7.5% or less, or 7.0% or less, 6.5% or less, or 6.0% or less, 5.5% or less, or 5.0% or less, 4.5% or less, or 4.0% or less, 3.5% or less, or 3.0% or less or 2.5% or less. The weight ratio of the surfactant to PVDF is determined as explained in detail below.

### Dispersant

The coating composition may comprise one or more dispersants. For purposes of this disclosure, a dispersant is a non-surfactant material that when added to a suspension of solid particles in a liquid promotes dispersion of the particles or maintains dispersed particles in the suspension. The dispersant may include inorganic, polymeric and small molecular dispersants. The dispersant may be a copolymer of diisobutylene (CAS #25167-70-8) and maleic anhydride (CAS #108-31-6). In such an example, the dispersant may comprise 30 wt % or greater, or 35 wt % or greater, or 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less, or 40 wt % or less, or 35 wt % or less of diisobutylene based on the total weight of the dispersant. The dispersant may comprise 30 wt % or greater, or 35 wt % or greater, or 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less, or 40 wt % or less, or 35 wt % or less of maleic anhydride based on the total weight of the dispersant.

In diisobutylene and maleic anhydride copolymer examples of the dispersant, the dispersant may have a weight average molecular weight from 10,000 daltons to 30,000 daltons. For example, the dispersant may have a weight average molecular weight of 10,000 daltons or greater, or 11,000 daltons or greater, or 12,000 daltons or greater, or 13,000 daltons or greater, or 14,000 daltons or greater, or 15,000 daltons or greater, or 16,000 daltons or greater, or 17,000 daltons or greater, or 18,000 daltons or greater, or 19,000 daltons or greater, or 20,000 daltons or greater, or 21,000 daltons or greater, or 22,000 daltons or greater, or 23,000 daltons or greater, or 24,000 daltons or greater, or 25,000 daltons or greater, or 26,000 daltons or greater, or 27,000 daltons or greater, or 28,000 daltons or greater, or 29,000 daltons or greater, while at the same time, 30,000 daltons or less, or 29,000 daltons or less, or 28,000 daltons or less, or 27,000 daltons or less, or 26,000 daltons or less, or 25,000 daltons or less, or 24,000 daltons or less, or 23,000 daltons or less, or 22,000 daltons or less, or 21,000 daltons or less, or 20,000 daltons or less, or 19,000 daltons or less, or 18,000 daltons or less, or 17,000 daltons or less, or 16,000 daltons, or less, or 15,000 daltons or less, or 14,000 daltons or less, or 13,000 daltons or less, or 12,000 daltons or less, or 11,000 daltons or less. The weight average molecular weight of the dispersant is determined using gel permeation chromatography.

Another example of a suitable dispersant includes the compound characterized by Structure (II):

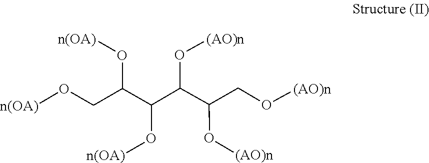

wherein each alkylene oxide (“AO”) may independently be ethylene oxide, propylene oxide, butylene oxide and/or combinations thereof in random or block order. Each n of Structure (II) may independently be from 5 to 40. For example, n may be 5 or greater, or 10 or greater, or 15 or greater, or 20 or greater, or 25 or greater, or 30 or greater, or 35 or greater, while at the same time, 40 or less, or 35 or less, or 30 or less, or 25 or less, or 20 or less, or 15 or less, or 10 or less, or 9 or less, or 8 or less, or 7 or less, or 6 or less. Ethylene oxide may account for 25 wt % or greater of the entire weight of Structure (II). For example, ethylene oxide may account for 25 wt % or greater, or 30 wt % or greater, or 40 wt % or greater, or 50 wt % or greater, or 60 wt % or greater, or 70 wt % or greater, or 80 wt % or greater, while at the same time, 90 wt % or less, or 80 wt % or less, or 70 wt % or less, or 60 wt % or less, or 50 wt % or less, or 40 wt % or less, or 30 wt % or less.

The coating composition may comprise 0 wt % of dispersant or from 0.1 wt % to 10.0 wt % of the dispersant based on the total weight of the coating composition. For example, the coating composition may comprise 0.1 wt % or greater, or 0.5 wt % or greater, or 1.0 wt % or greater, or 1.5 wt % or greater, or 2.0 wt % or greater, or 2.5 wt % or greater, or 3.0 wt % or greater, or 3.5 wt % or greater, or 4.0 wt % or greater, or 4.5 wt % or greater, or 5.0 wt % or greater, or 5.5 wt % or greater, or 6.0 wt % or greater, or 6.5 wt % or greater, or 7.0 wt % or greater, or 7.5 wt % or greater, or 8.0 wt % or greater, or 8.5 wt % or greater, or 9.0 wt % or greater, or 9.5 wt % or greater, while at the same time, 10.0 wt % or less, or 9.5 wt % or less, or 9.0 wt % or less, or 8.5 wt % or less, or 8.0 wt % or less, or 7.5 wt % or less, or 7.0 wt % or less, or 6.5 wt % or less, or 6.0 wt % or less, or 5.5 wt % or less, or 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less, or 0.5 wt % or less, or 0.2 wt % or less of the dispersant based on the total weight of the coating composition.

### Methods of Making the Coating Composition and Coating a Substrate

The coating composition is formed by a method including the step of dispersing a plurality of polyvinylidene difluoride particles in a mixture of water and a surfactant having a hydrophobe branching degree of 5 or greater, wherein the composition is free of a fluorinated surfactant. The act of dispersing the of polyvinylidene difluoride particles in the mixture of water and surfactant may be accomplished in a variety of ways. For example, the coating composition can be placed in a milling jar along with beads (e.g., glass, ZrO, Al₂O₃, etc.) and milled for a predetermined amount of time. Such a milling method is advantageously used where the PVDF particles are added in the coating composition at a size larger than desired in the dispersion. Additionally or alternatively, the PVDF particles may be directly mixed or agitated within the combined water and surfactant. It will be understood that the PVDF particles, surfactant, water, dispersant and any other additives may be added together in any order.

The coating composition is useful for the formation of coated substrates. A method of coating a substrate can be performed using the step of applying the coating composition to a substrate. The coating composition may be applied to the substrate in a variety of manners. For example, the substrate may be dipped into the composition, the composition may be sprayed onto the substrate, the substrate may be a continuous sheet which is passed through a bath off the coating composition and/or other methods of applying the coating composition to the substrate. The substrate may comprise a polymeric material, a metal, a ceramic, an amorphous material (e.g., glass) and/or other types of materials. Examples of polymeric materials the substrate can be include low density polyethylene, medium density polyethylene, high density polyethylene, polyolefin elastomers, copolymers of one or more alpha-olefins and another monomer as well as other types of polymeric materials. In an exemplary use, the coating composition may be applied to a polymeric substrate to form a separator layer for a battery.

### Examples

### Materials

The following materials were used in the formation of the inventive examples (“IE”) and comparative examples (“CE”).

Surfactant 1 is a surfactant having 90 wt % actives solution of water and Structure (I) having an n of 8 and R₁ is H. Surfactant 1 has a hydrophobe branching degree of 5. Surfactant 1 is available from The Dow Chemical Company, Midland Michigan.

Surfactant 2 is a surfactant having 90 wt % actives solution of water and Structure (I) having an n of 11 and R₁ is H. Surfactant 2 has a hydrophobe branching degree of 5. Surfactant 2 is available from The Dow Chemical Company, Midland Michigan.

Dispersant 1 is formed from 45 wt % to 55 wt % monomeric structural units of diisobutylene with the remainder being maleic anhydride. The dispersant has a weight average molecular weight of approximately 16,500 daltons and is available from The Dow Chemical Company, Midland Michigan.

Dispersant 2 is a dispersant having Structure (II) wherein each AO chain is composed of ethylene oxide units and propylene oxide units in block order, and the average repeat unit n is around 37 in each branch. Dispersant 2 is available from The Dow Chemical Company, Midland Michigan.

Surfactant 3 is 3,5,5-trimethylhexyl ethoxylate having a hydrophobe branching degree of 4 and is available from Sigma Aldrich, St. Louis Missouri.

Surfactant 4 is 2-Ethyl Hexanol EO-PO Nonionic Surfactant having a CAS number of 64366-70-7 and a hydrophobe branching degree of 2. Surfactant 4 is available from The Dow Chemical Company, Midland Michigan.

Surfactant 5 is C12-14-secondary alcohol ethoxolates having a CAS number of 84133-50-6 and a hydrophobe branching of 2. Surfactant 5 is available from The Dow Chemical Company, Midland Michigan.

Surfactant 6 is an isotridecyl alcohol ethoxylate having an average hydrophobe branching of 4 and is commercially available as LUTENSOL™ TO from BASF corporation, Ludwigshafen, Germany.

PVDF is polyvinylidene difluoride homopolymer particles commercially available as KYNAR™ HSV 900 from Arkema, Colombes, France.

ZrO beads were 0.8 to 1.2 mm diameter ZrO beads from Sinopharm Chem. Reagent Co. Ltd., China.

### Sample Preparation

The comparative and inventive examples were prepared by loading a pre-mixed mixture of surfactant, PVDF powder, dispersant (IE1) and water into in milling jar. ZrO beads were weighed and added. The jar was installed in a sand mill machine from Shanghai Dedong and cooling water was started on the milling jar before the milling process was commenced. The milling process was carried out at 1400 revolutions per minute for 4 hours. After the allotted time, the ZrO beads were filtered out by running the milled mixture though a 500 mesh nylon sieve. The milled PVDF dispersion samples were applied to conductive tape for characterization by a NOVA™ Nanosem 630 scanning electron microscope from FEI Company. All examples were stored at approximately 23° C. for 7 days without agitation for observation of agglomeration and sedimentation. The weight ratio of surfactant to PVDF is calculated by dividing the weight in grams of surfactant present (taking into account any diluents in the surfactant) divided by the weight in grams of PVDF particles and multiplying by 100. The examples were evaluated both by eye and using the scanning electron microscope. Examples which were unable to be redispersed after the storage were termed to be agglomerated or tightly agglomerated with the differentiation being in the amount of material that could be freed from the bottom of the jars by agitation. Examples where the PVDF could be agitated to resume a uniform dispersion were classified as re-dispersible.

### Results

Table 1 provides the composition of IE1-IE5 and CE1-CE4. The constituents of the examples are provided in grams.

TABLE 1

| Formulation | CE1 | CE2 | CE3 | CE4 | IE1 | IE2 | IE3 | IE4 | IE5 |
|---|---|---|---|---|---|---|---|---|---|
| Surfactant 1 | | | | | 0.777 | 2.331 | 0.7 | | 0.3 |
| Surfactant 2 | | | | | | | | 0.7 | |
| Dispersant 2 | | | | | 0.7 | | | | |
| Dispersant 1 | | | | | 0.7 | | | | |
| Surfactant 3 | 0.4725 | | | | | | | | |
| Surfactant 4 | | 0.4725 | | | | | | | |
| Surfactant 5 | | | 0.4725 | | | | | | |
| Surfactant 6 | | | | 0.4725 | | | | | |
| PVDF | 10.5 | 10.5 | 10.5 | 10.5 | 21 | 21 | 10.5 | 10.5 | 6 |
| Deionized water | 24 | 24 | 24 | 24 | 46.8 | 46.7 | 23.8 | 23.8 | 13.7 |
| zirconium beads | 100 | 100 | 100 | 100 | 105 | 105 | 105 | 105 | 100 |
| Weight ratio of | 4.50% | 4.50% | 4.50% | 4.50% | 10% | 10% | 6% | 6% | 4.5% |
| surfactant to PVDF | | | | | | | | | |

Table 2 provides the results of the different surfactants used on the appearance of the initial dispersion, the morphology after 7 days of storage and the average particle size peaks present.

TABLE 2

| | Appearance right | |
|---|---|---|
| Example | after milling process | 7 days storage |
| CE1 | Uniform | Tightly |
| | | agglomerated |
| CE2 | Non-uniform | Tightly |
| | | agglomerated |
| CE3 | Non-uniform | Tightly |
| | | agglomerated |
| CE4 | Uniform | agglomerated |
| IE1 | Uniform | Uniform |
| IE2 | Uniform | Re-dispersible |
| IE3 | Uniform | Re-dispersible |
| IE4 | Uniform | Re-dispersible |
| IE5 | Uniform | Re-dispersible |

Referring now to Tables 1 and 2, all inventive examples and comparative example 1 and 4 exhibited a uniform milky dispersion after the milling process. However, after 7 days storage at 23° C., CE1-CE4 exhibited phase separation which resulted in a strong deposit forming on the bottom of the sample containers. The deposits of CE1-CE4 could not be re-dispersed by manual shaking. IE1 remained uniform after 7 days storage. IE2-IE5 exhibited phase separation, but the deposit could be re-dispersed by manual shaking. CE1-CE4 demonstrate that the selection of surfactants having a hydrophobe branching of 4 or less, despite different surfactants being used, are unable to prevent agglomeration. However, IE1-IE5, all utilizing a surfactant having a hydrophobe branching of 5 are able to achieve an aqueous dispersion of PVDF that is initially uniform and is re-dispersible after a period of 7 days. It is believed that surfactants having a hydrophobe branching degree of 6 or greater would exhibit the same resistant to agglomeration and would be re-dispersible as the steric hinderance effects would be even greater.

What is claimed is:

1. A coating composition, comprising:
water;
a plurality of polyvinylidene difluoride particles; and
a surfactant having a hydrophobe branching degree of 5 or greater,
wherein the composition is free of a fluorinated surfactant.

2. The coating composition of claim 1, wherein the surfactant is a non-ionic surfactant.

3. The coating composition of claim 1, wherein a weight ratio of the surfactant to the polyvinylidene difluoride particles is from 2.0% to 15.0%.

4. The coating composition of claim 1, wherein the coating composition comprises from 20 wt % to 70 wt % of the polyvinylidene difluoride particles based on a total weight of the coating composition.

5. The coating composition of claim 1, further comprising:
0.1 wt % to 10.0 wt % of a dispersant, wherein the dispersant is a random copolymer of diisobutylene and maleic anhydride.

6. The coating composition of any one of claims 1-5, further comprising:
0.1 wt % to 10.0 wt % of a dispersant, wherein the dispersant has structure (II): 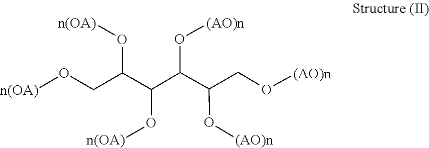
wherein each AO may independently be ethylene oxide, propylene oxide, butylene oxide and combinations thereof in random or block order, further wherein each n of Structure (II) may independently be from 5 to 40.

7. The coating composition of any one of claims 1-6, wherein the surfactant has structure (I): 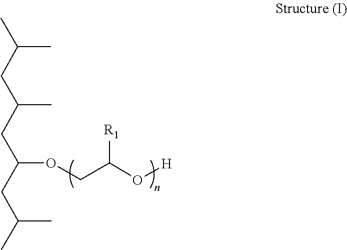
wherein n of Structure (I) is 3 to 11 and R₁ for each n is independently selected from the group consisting of H or an alkyl having 1 or 2 carbons.

8. The coating composition of claim 7, wherein n of Structure (I) is 8 to 11 and R₁ is H.

9. A method of forming a coating composition, comprising the step of:
dispersing a plurality of polyvinylidene difluoride particles in a mixture of water and a surfactant having a hydrophobe branching degree of 5 or greater, wherein the composition is free of a fluorinated surfactant.

10. A method of coating a substrate, comprising the step of:
applying the coating composition of claim 9 to a substrate.
